(19) United States
(12) Patent Application Publication
(10) Pub. No.: US 2025/0362080 A1
(43) Pub. Date: Nov. 27, 2025

(54) METHOD FOR RECOVERING THERMAL ENERGY IN A MATERIAL DRYING PROCESS, HEAT RECOVERY SYSTEM, AND ARRANGEMENT FOR DRYING MATERIAL

(71) Applicant: SPINNOVA OYJ, Jyväskylä (FI)

(72) Inventors: Markku KATAJA, Jyväskylä (FI); Juha SALMELA, Jyväskylä (FI); Arttu PELTONEN, Jyväskylä (FI); Markko MYLLYS, Jyväskylä (FI); Pasi SELENIUS, Jyväskylä (FI)

(21) Appl. No.: 18/873,927

(22) PCT Filed: Jun. 14, 2023
(86) PCT No.: PCT/FI2023/050355

§ 371 Date: Dec. 11, 2024

(30) Foreign Application Priority Data
Jun. 17, 2022 (FI) 20225544

(51) Int. Cl. F26B 23/00; F26B 3/02; F26B 21/04

(52) U.S. Cl. CPC F26B 23/005; F26B 3/02; F26B 21/04

(57) ABSTRACT

A method for recovering thermal energy in a material drying process, the method comprising, providing a material to be dried comprising a liquid content, providing thermal energy to evaporate at least a portion of the liquid from the material, providing a drying gas flow to carry the vapor of the evaporated liquid and the related latent heat from the material, gathering the gas flow carrying the vapor and the latent heat, recovering at least most or essentially all of the vapor carried by the gas flow to obtain recovered liquid and recovered gas flow by condensing the at least most or essentially all of the vapor content in the gathered gas flow, recovering the thermal energy used for evaporation and the latent heat of vapor carried by the gas flow by heat exchanging and condensing to obtain recovered thermal energy by the heat exchanging and condensing, recirculating at least a portion of the recovered thermal energy as the thermal energy used for evaporation and/or recirculating at least a portion of the recovered gas flow as the drying gas flow, and/or recirculating at least a portion of the recovered liquid to the material to be dried comprising a liquid content.

### TECHNICAL FIELD OF THE INVENTION

The invention relates to drying processes and apparatuses in general. More specifically, the invention relates to a method for recovering thermal energy in a drying process, a heat recovery unit, and an arrangement for drying a material comprising a liquid content, where thermal energy may be recovered, while essentially all or at least most of used liquid and/or gas may be also recovered.

### BACKGROUND OF THE INVENTION

Many manufacturing processes require a material comprising a liquid content to be dried. Various processes involve drying of a mixture of fibers, such as cellulose fibers, and one or more liquids. Examples of such processes are papermaking processes and processes for manufacturing yarn or filaments from cellulose fibers. Water is mixed with a raw material, e.g. fiber, to make a mixture which is then dried by providing heat and air.

Such manufacturing processes involve the need for large amounts of resources, such as water, air, and energy. Traditionally, many manufacturing processes are associated with adverse environmental effects. Water and energy, for instance, are valuable resources that should be conserved. These resources are also expensive and will add to the overall manufacturing costs. However, the prior art processes involve disposing of the air containing latent heat from the dried material and evaporated liquid. This heat and liquid is thus not reusable.

There is a need for more environmentally sustainable processes for drying materials.

### SUMMARY OF THE INVENTION

The object of the invention is to alleviate at least some of the problems in the prior art. In accordance with one aspect of the present invention, a method for recovering thermal energy in a material drying process is provided, the method comprising, at least after a starting phase where a starting volume of liquid and a starting amount of gas flow is obtained,
providing a material to be dried comprising a liquid content,
providing thermal energy to evaporate at least a portion of the liquid from the material,
providing a drying gas flow to carry the vapor of the evaporated liquid and the related latent heat from the material,
gathering the gas flow carrying the vapor and the latent heat,
recovering at least most or essentially all of the vapor carried by the gas flow to obtain recovered liquid and recovered gas flow by condensing the at least most or essentially all of the vapor content in the gathered gas flow,
recovering the thermal energy used for evaporation and the latent heat of vapor carried by the gas flow by heat exchanging and condensing to obtain recovered thermal energy by the heat exchanging and condensing,
recirculating at least a portion of the recovered thermal energy as the thermal energy used for evaporation and/or
recirculating at least a portion of the recovered gas flow as the drying gas flow, and/or
   recirculating at least a portion of the recovered liquid to the material to be dried comprising a liquid content.

A heat recovery system is also provided according to independent claim 11 and an arrangement for receiving a material comprising liquid content and drying said material is provided according to independent claim 16.

Through the present invention, it may be possible to implement a method for thermal energy recovery while drying a material comprising a liquid content, where amount of overall liquid, air, and/or energy that is needed for the drying process during the e.g. lifetime of the associated manufacturing facility or during a given time period for producing a certain amount of dried material is reduced. A cost of manufacturing the dried material may then be lower than in known methods for manufacturing a corresponding dried material or product.

Liquid, gas, and/or energy used in the drying may be recovered instead of wasted and may thereafter be reused in the drying process or provided to other processes. This may provide a method where these resources are conserved more efficiently than in the prior art, leading to a more environmentally friendly process.

In one embodiment, the method may be a closed process with respect to the liquid. Here, essentially all or at least 90%, preferably at least 99%, of the liquid may be recirculated to the material to be dried comprising a liquid content.

In one embodiment, the method may be a closed process with respect to the gas flow. Essentially all or at least 90%, preferably at least 99%, of the gas flow may be recirculated as the drying gas flow.

In prior art methods, most of the used liquid and the gas flow, or at least a portion that is greater than in the present invention, is nor recovered and/or not recirculated, such that most of the liquid and/or most of the gas flow is wasted and cannot be reused. For instance, it is well known that many prior art manufacturing facilities expel vast amounts of water vapor into the environment after a material comprising liquid content is dried.

A manufacturing facility for manufacturing a material or providing a dried material according to the present invention may be of smaller size than a manufacturing facility of the prior art. This is due to the possibility of reducing an amount of infrastructure required for circulation of energy, liquid, and/or gas, as in the present invention these are recirculated to a high degree. An engine room for gas, for instance, may be significantly smaller in a facility according to the present invention than in the prior art.

In one embodiment, the method may comprise recovering at least 50%, preferably at least 60%, and more preferably at least 70% or 80% of the thermal energy used for evaporation, and preferably recirculating at least a portion of the recovered thermal energy as the thermal energy for evaporating the liquid from the material. In one embodiment, at least most or essentially all of the recovered thermal energy is recirculated as the thermal energy for evaporating the liquid from the material. In other embodiments, only a portion of the thermal energy required for evaporating the liquid from the material is provided as the recovered thermal energy, and a portion of the thermal energy required to sustain the process after the starting phase will be needed from an external source during the process. Here, to provide an excess of thermal energy being directed to the process, it may be advantageous to recirculate only a portion of the recovered thermal energy as the thermal energy for evaporating the liquid from the material. The remaining recovered thermal energy may be directed to an external process.

Thus, in some embodiments, instead of or in addition to recirculating the recovered energy and reusing it in the process of drying the material, at least a portion of the recovered thermal energy may be reused in some other process or may be directed to an external process to be reused. For example, in one embodiment at least some (such as 5%-70%, e.g. about 10%-30%) of the recovered thermal energy may be directed to an external process for reuse while the remaining recovered thermal energy may be recirculated as the thermal energy for drying the material. At least a portion of the recovered thermal energy may be sold to a third party. A third party may be a district heating provider, for instance.

Embodiments of the invention may involve materials comprising fibers, for instance fibers made of natural raw materials, such as cellulose. One or more liquids used may comprise at least water. The method may comprise providing a mixture comprising at least cellulose fibers and water as the material to be dried.

The method may be related to a method for manufacturing filaments from the material to be dried, such as by extruding the material to be dried from one or more nozzles and providing said material to be dried to a drying surface.

In one embodiment, the thermal energy is provided to a drying surface configured to receive the material to be dried. At least a portion of the recovered thermal energy may be recirculated to the drying surface in addition to being recirculated to the drying gas flow.

The method may comprise directing the gas flow carrying the vapor and the latent heat to a heat recovery unit comprising at least a condensing heat exchanger unit. The condensing heat exchanger unit may utilize a cooling fluid to condense the liquid at the condensing heat exchanger unit in order to recover the thermal energy and the latent heat carried by the gas flow. With a condensing heat exchanger, at least most or essentially all of the evaporated liquid may be recovered. In the prior art, a larger portion of the evaporated liquid may usually be provided in a wasted air flow.

The cooling fluid may be provided by a cooling fluid providing device that is preferably a device that is separate from the condensing heat exchanger unit, for providing a cooling fluid to the condensing heat exchanger unit for exchanging the heat from the drying gas flow by the heat exchanger and thereby cooling the gas flow and condensing the liquid carried by the gas flow to recover also said latent heat from the gas flow, and directing at least a portion of the thus obtained recovered thermal energy to said cooling fluid.

In one embodiment, the cooling fluid of a condensing heat exchanger unit is provided by a heat pump unit, and the method may comprise directing at least a portion of recovered thermal energy obtained at the condensing heat exchanger unit to the heat pump unit to recover additional thermal energy from the recovered thermal energy obtained at the condensing heat exchanger unit to obtain further recovered thermal energy, and directing said recovered additional thermal energy to an external unit and/or recirculating the additional recovered thermal energy as the thermal energy used for evaporation and/or the processing of the material to be dried. The heat pump unit may provide the heat exchanger unit with refrigerant fluid that is cool enough to enable the condensation of the evaporated liquid.

In an embodiment, at least a portion of the recovered thermal energy may be provided at least to the drying gas flow and the drying gas flow may be heated to a temperature of under 200° C., preferably under 150° C. or under 100° C. Embodiments of the invention may therefore be advantageous in processes involving drying material where a used drying gas flow may be kept under a temperature of e.g. 150° C. An example is the drying of a mixture comprising at least cellulose fibers and water, where it may be advantageous to keep the temperature of a drying gas flow under a threshold temperature, e.g. under 100° C., such as under 90° C. or under 80° C. Such embodiments are readily made possible utilizing known heat pumps. Methods of drying material according to the invention are however not only limited to such temperatures, and also higher temperatures may be provided, especially regarding embodiments where the provision of enhanced heat pump units is possible. The invention, however, may provide particular advantages in processes where a temperature of drying gas flow or other temperature that may be utilized in the drying process may be kept under e.g. 150° C. and an amount of recovered thermal energy, recovered liquid, and/or recovered gas flow may be improved over existing similar processes.

The term “unit” may herein refer to a separate physical entity that is configured to perform the specified functions or may refer to one or more other elements of a heat recovery system or arrangement that are capable of carrying out the discussed functionalities.

The drying of a material refers to evaporation of at least a portion of liquid content comprised in the material. After a material is dried, the material may be completely void of liquid but may yet comprise some residual portion of liquid. A dried material may e.g. comprise 0.1% wt.-5% wt., preferably 0.1% wt.-1% wt of liquid. This may refer to the amount of liquid in the material immediately after the drying process has concluded, while the dried material may begin to absorb moisture from the environment essentially immediately after the drying process has ended and comprise a larger amount of liquid e.g. during a storage period. However, the present invention may also be utilized in connection with processes of drying of materials where the “dried” material may also comprise a larger amount of liquid, the drying referring to partial evaporation of liquid content.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The presented considerations concerning the various embodiments of the method may be flexibly applied to the embodiments of a heat recovery system or arrangement mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 schematically illustrates a process diagram of a method of the invention utilizing at least part of a heat recovery system according to one embodiment, where thermal energy, gas flow, and/or liquid may be recirculated,

FIG. 2 shows a process diagram of a method of the invention utilizing at least part of a heat recovery system according to one embodiment, where thermal energy may be recirculated,

FIG. 3 shows schematically at least a portion of an arrangement according to one more embodiment of the invention,

FIG. 4 shows a process diagram of a method of the invention utilizing at least part of a heat recovery system according to one embodiment, where gas flow and thermal energy may be recirculated,

FIG. 5 shows a process diagram of a method of the invention utilizing at least part of a heat recovery system according to one embodiment, where thermal energy and liquid may be recirculated, and

FIG. 6 shows a process diagram of a method t of the invention utilizing at least part of a heat recovery system according to one embodiment, where thermal energy, gas flow and liquid may be recirculated.

### DETAILED DESCRIPTION

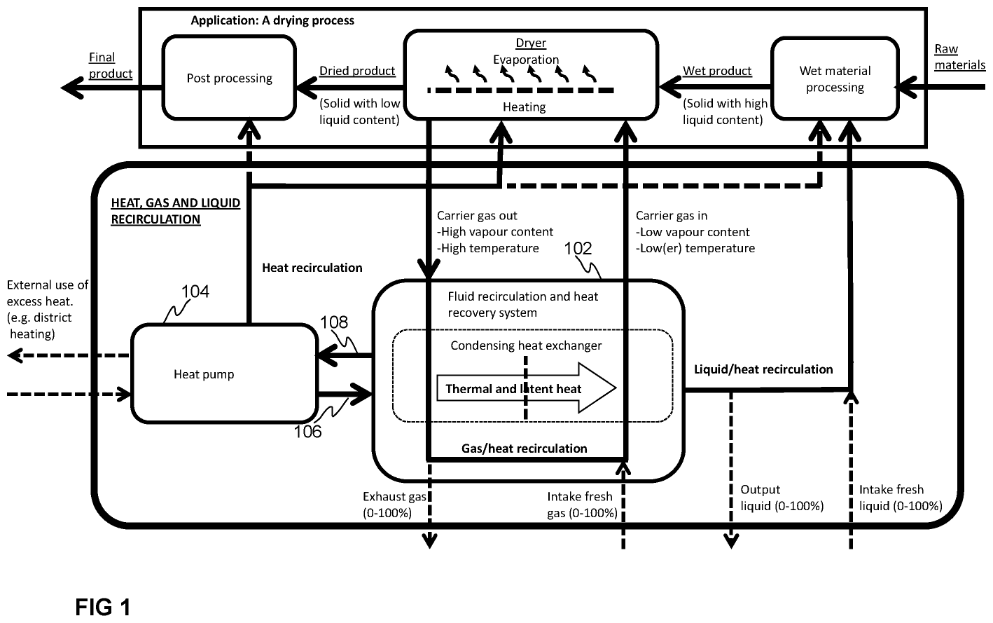

FIG. 1 schematically illustrates a process diagram of a method of the invention utilizing at least part of a heat recovery system according to one embodiment, where thermal energy, gas flow, and/or liquid may be recirculated. The method is shown in connection with a material manufacturing process comprising at least a drying process. The recirculation may refer to recirculation of recovered thermal energy, gas flow, and/or liquid back into the material manufacturing process (including the drying process and/or the processes before and/or after the evaporation process, i.e. recirculation may also be to the wet material processing and/or post-processing of the dried product).

In the wet process, one or more solid materials that comprise the material to be dried (and thus the main part of the final product produced in the material manufacturing process), may be mixed with optional additives and a liquid substance that may be a carrier liquid or solvent to provide the material to be dried comprising a liquid content. The liquid may be a pure substance or a mixture of substances in liquid form used as the carrier fluid or solvent within the wet process.

The drying process may be considered as the process where the liquid content of the material received from the wet process is reduced by evaporation, giving rise to vapor, which is the gaseous form of the liquid that is evaporated.

The figure depicts at least a portion of a heat recovery system that may be utilized in embodiments of the invention. FIG. 1 also provides an illustration of how different flows of thermal energy, gas, and/or liquid may be directed in the method and associated process. The thermal energy, gas, and/or liquid or other used media may be maneuvered between the e.g. different units of the system through (re)circulation or delivery systems comprising e.g. conduits.

Through embodiments of the invention, thermal energy, gas flow and/or liquid may be recirculated. The recirculation of any one of the previous may be partial. In addition to be being recirculated for use in the drying process or the process of manufacturing the product, the recovered heat, gas, and/or liquid may be directed to some other external process. For instance, in the example of FIG. 1, thermal energy may be directed to external use, such as district heating. A portion of recovered gas and/or recovered liquid may be directed to external entities as exhaust gas or output liquid.

As stated previously, the recovered thermal energy, gas, and/or liquid may be recirculated to one or more subprocesses in the manufacturing process. In the example of FIG. 1, the recovered gas is shown as possibly being recirculated to the drying process, the recovered liquid is shown as being recirculated to the wet process, and the recovered thermal energy is shown as being recirculated (at least partially) to at least the drying process. The recovered thermal energy may, additionally or alternatively, be recirculated to the wet process and/or post-processing of the dried product.

The present invention relates at least to a heat recovery system that may be configured to be utilized for recovering thermal energy in the material drying process for drying a material comprising liquid content. The heat recovery system may thus be configured to receive a drying gas flow carrying vapor of evaporated liquid and the related latent heat from a material comprising liquid content from which said liquid content has been evaporated using thermal energy, and transfer heat from the drying gas flow by a heat exchanger to cool said drying gas flow to condense essentially all or at least most of the vapor to provide a recovered liquid, recovered gas flow, and recovered thermal energy by the heat exchanging and condensing.

The heat recovery system may comprise one or more elements or units that may work together to provide the heat exchanging and condensing. One unit may also comprise a plurality of elements. For instance, a heat exchanging unit may comprise a plurality of heat exchangers.

In one embodiment, the heat recovery system comprises at least one condensing heat exchanger unit 102 and a device 104 for providing a cooling fluid to the condensing heat exchanger unit 102. The cooling fluid may be delivered to the heat exchanger unit 102 via a cooling fluid delivery system 106.

The heat exchanger unit 102 is configured to receive a drying gas flow carrying vapor and latent heat from the material to be dried. Utilizing the cooling fluid, the heat exchanger unit 102 may cool the drying gas flow and condense the evaporated liquid to obtain the recovered liquid and recovered thermal energy. The drying gas flow/carrier gas may be cooled to at least a dew point temperature of the gas flow in order to recover the latent heat by the condensing.

The condensing heat exchanger unit 102 may comprise a plurality of heat exchangers, at least one of which is a condensing heat exchanger.

Various implementations of a drying process may be possible with the heat recovery system, such as hanging of the material to be dried in an air space such that a heated drying gas flow may be used to evaporate liquid or a drying surface may be utilized as will be discussed further below.

The device 104 for providing the cooling fluid may in some embodiments be any type of unit that is configured to provide a cooling fluid. The cooling fluid device 104 may be a cooling system 104 that e.g. delivers cooling fluid from an external source. In one advantageous embodiment the device 104 is a heat pump unit. A heat recovery system may comprise a thermal energy delivery system 108 (implemented e.g. using conduits) and the condensing heat exchanger unit 102 may be configured to direct at least a portion of the obtained recovered thermal energy to the heat pump unit 104 to recover further thermal energy from the recovered thermal energy obtained at the condensing heat exchanger unit 102 to obtain additional recovered thermal energy.

The heat pump unit 104 may then be configured to direct the recovered additional thermal energy to an external unit and/or recirculate the additional recovered thermal energy as the thermal energy used for evaporation and/or the processing of the material to be dried using a thermal energy recirculation system comprising e.g. conduits through which the thermal energy may be delivered for example via a fluid medium.

A cooling fluid device 104 is advantageously a device that is separate from the condensing heat exchanger unit 102, i.e. the device 104 is not integrated with the condensing heat exchanger unit 102 and is provided as an external device 104. The condensing heat exchanger unit 102 could be provided in connection with or closer to other portions of the heat recovery system, while the device 104 may then reside at a distance from the condensing heat exchanger unit 102. The device 104, such as heat pump unit, and the condensing heat exchanger unit 102 may be coupled only via the cooling fluid delivery system 106 and thermal energy delivery system 108.

For example, a production facility where the process for drying the material is carried out may comprise a production building where the drying process is executed and where e.g. at least the condensing heat exchanger unit 102 may reside. A device providing the cooling fluid, such as heat pump unit 104, may then reside in a separate building or structure.

A distance between the device 104 and other portions of a heat recovery system may for example be tens of meters or several kilometers. The cooling fluid delivery system 106 and thermal energy delivery system 108 may then couple the devices.

With the e.g. heat pump unit 104 being provided as a separate device and separate from the condensing heat exchanger unit 102, one heat pump unit 104 may serve one heat recovery unit or one drying process, yet it may also serve a plurality of heat recovery units or drying processes, which may be similar processes or may be different types of drying processes.

With a separate facility for the cooling fluid device 104 or at least by providing a separate cooling fluid device 104, one device 104 may be utilized at a capacity that exceeds that of using a dedicated and integrated cooling fluid device 104 in connection with one drying process and one heat recovery unit.

The heat recovery system may additionally comprise a liquid recirculation system configured to receive the recovered liquid and recirculate the recovered liquid to a mixing unit for mixing the material with the liquid to provide the material comprising liquid content.

The heat recovery unit may additionally comprise a gas flow recirculation system configured to receive the recovered gas flow and recirculate the recovered gas flow as the drying gas flow in the process for drying material.

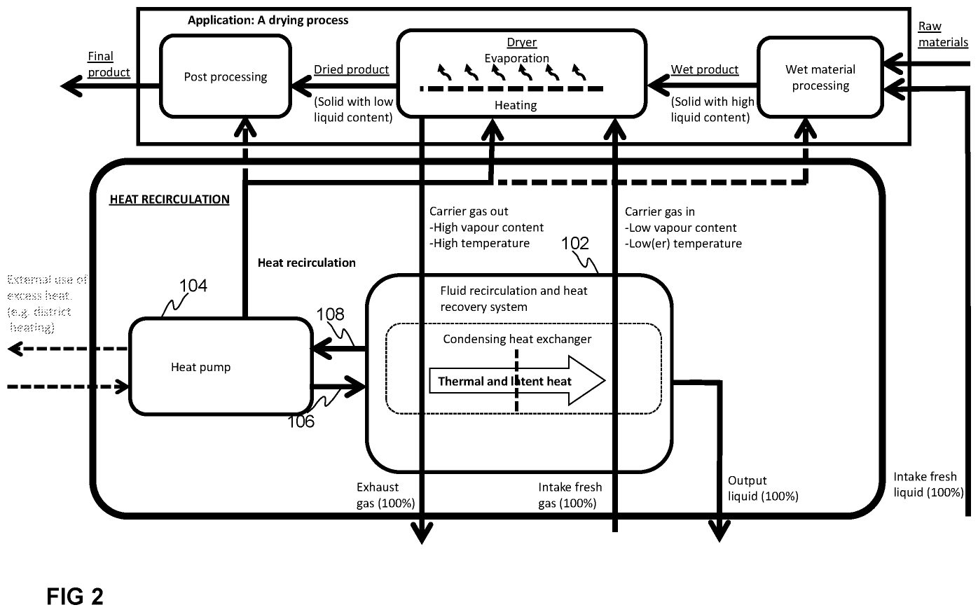

FIG. 2 shows a process diagram of a method of the invention utilizing at least part of a heat recovery system according to one embodiment, where thermal energy may be recirculated. In this embodiment, gas and liquid are not recirculated, and the recovered liquid and recovered gas are provided as an output liquid and exhaust gas which may be directed to some external entity or to the environment or a waste facility, for instance.

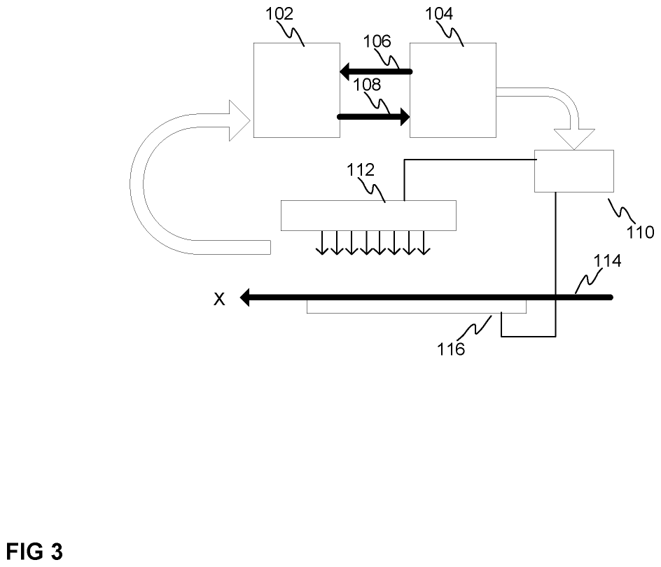

FIG. 3 schematically illustrates one example of an arrangement for receiving a material comprising liquid content and drying the material. The arrangement comprises at least a heat recovery system, which can be similar to the heat recovery system of FIG. 1 or FIG. 2. FIG. 3 may be considered to depict at least a portion of equipment that may be used in a material manufacturing process comprising subprocesses of a wet process and a drying process. The embodiment of FIG. 3 may be considered applicable particularly in connection with the embodiment of FIG. 2 where heat is recirculated.

The arrangement may additionally comprise at least one heating element 110 for providing thermal energy to evaporate at least a portion of the liquid from the material. The arrangement may also comprise at least one gas flow element 112 which is configured to provide a drying gas flow to carry the evaporated liquid and latent heat from the material. The thermal energy from the heating element 110 may be provided at least to the gas flow element 112 such that the drying gas flow is a heated drying gas flow. A heating element 110 may also be comprised in connection with a gas flow element 112. A heating element 110 may be configured to receive at least a portion of the used energy from an external source. At least a portion of the used energy may also be recovered thermal energy that is recirculated and is the recovered thermal energy that is recovered by the heat recovery system.

The gas flow may comprise a pure substance or mixture of substances in gaseous form used in the drying process to dry the material and receive vapor (evaporated liquid from the material comprising liquid content) and to carry it out of the drying process. In addition, gas flow may be used to carry heat in the drying process. Typically, the gas is air and may contain volatile additives and/or impurities. The gas flow is typically also a heated gas flow.

The arrangement may be configured to receive the material comprising liquid content. In the example of FIG. 2, the arrangement comprises a drying surface 114 configured to receive the material to be dried comprising a liquid content. The drying surface 114 may for instance comprise a metal material or some other material that conducts thermal energy. The drying surface 114 may be configured to be movable with respect to the other elements of the arrangement, such that the material to be dried is also movable with respect to the other elements of the arrangement. The drying surface 114 may be movable in a machine axis X.

In this example, the heating element 110 is configured to provide thermal energy to or via the gas flow and a surface heating element 116. An arrangement may also comprise a plurality of gas flow elements and/or surface heating elements. The surface heating element 116 may be in thermal connection with the drying surface 114. The heating element 110 may be considered as a separate heating element 110 as depicted, or each of the one or more surface heating elements 116 and the one or more gas flow elements 112a, 112b, 112c may comprise or be in connection with a separate heating element 110.

The drying gas flow may in one embodiment be heated to under 150° C. or under 100° C. In the use case of drying a mixture of cellulose fibers and water in a process to form yarn or filaments, it may be advantageous to keep the temperature of the drying gas flow under 90° C.

In embodiments with a plurality of gas flows, the drying gas flows may be essentially similar or some or all of the drying gas flows may differ from each other.

An amount of thermal energy provided to the at least one surface heating element 116 may advantageously be such that the temperature of a drying surface 114 is kept under 100° C. This may be useful in the case of drying a mixture of cellulose-derived fibers and water in a process where the dried end product is a filament, as the integrity or quality of the resulting filament may be higher if the water does not boil.

As the material is dried, the vapor of the evaporated liquid and related latent heat from the material is moved to the drying gas flow(s). The drying gas flow carrying the evaporated liquid and latent heat from the material is directed to the heat recovery system or at least one unit of the heat recovery system, advantageously to the condensing heat exchanger unit 102. The directing may be enabled through a drying gas flow gathering system for instance by using one or more suction devices and conduits e.g. near or at the gas flow element(s) 112.

The heat recovery system may operate as described in connection with FIG. 1, and a thermal energy recirculation system, with the recirculation system possibly comprising e.g. different parts or conduits for directing of thermal energy, may recirculate at least a portion of the obtained recovered thermal energy to the at least one heating element 110. Of course, heat may additionally be recirculated to a wet process or post-processing of the dried product.

The heat recovery system may additionally comprise a liquid recirculation system for recirculating at least a portion of the recovered liquid to the wet process.

The wet process may be implemented using at least one mixing unit configured to receive the material and mix the material with the liquid to obtain a material comprising liquid content. The mixing unit may be external to the arrangement or the arrangement may comprise a mixing unit. The mixing unit may comprise or e.g. be coupled to one or more nozzles that provide the material to be dried to e.g. a drying surface 114. In one embodiment, the mixing unit also comprises or is coupled to the heating element 110 such that the material comprising liquid content may be preheated.

The heat recovery system may additionally comprise a gas flow recirculation system configured to receive the recovered gas flow and recirculate the recovered gas flow (to the one or more gas flow elements 112) as the drying gas flow in the drying process. The recirculation systems are not depicted in the figures or depicted only schematically, and it should be conceivable for the skilled person how such systems involving e.g. conduits for transferring the recovered thermal energy, liquid, and/or gas flow may be implemented.

The arrangement may additionally comprise a control entity (not depicted) configured to receive one or more determined parameters, which may e.g. comprise measured parameters, such as one or more determined temperatures or humidities, and the control entity may be configured to control an amount of thermal energy provided by the at least one heating element 110 and/or control an amount of gas flow provided by the at least one gas flow element 112 based on the determined parameters and/or control an amount of liquid received by a mixing unit.

The control unit may comprise one or more processors and may be implemented via e.g. one or more computing devices that may be in wired or wireless contact with any of the other components of the arrangement.

One or more temperatures of the drying surface 114 and/or one or more temperatures and/or humidities of the drying gas flowcarrying vapor and latent heat may be utilized by the control entity. The control entity may be configured to maintain the temperatures or humidities at or near predetermined values by controlling the system components. For instance, if a temperature of the drying surface 114 at a certain measurement location is lower than a predetermined value, the control entity may control the heating element 110 to direct more thermal energy to said measurement location.

Additionally or alternatively, the control entity may receive a request from one or more constituents of the arrangement, such as a mixing unit or heating element 110 to provide a requested amount of e.g. liquid or thermal energy. The control entity may be configured to control a liquid recirculation system, thermal energy recirculation system, and/or gas flow recirculation system based on process control logic and/or requests from the system constituents such that the drying method is optimized to

[symbol]

The arrangement may be configured to receive a starting a volume of liquid, starting amount of energy, and a starting amount of gas flow from external sources and/or from outside of the system at a start phase of a method/process. After the process has been started, the process may be a closed process at least in view of liquid and/or gas, where no additional liquid and/or gas in required from an external source for a given amount of process time.

The control entity may in some embodiments be utilized to provide a suitable amount of starting amounts of liquid, gas, and/or thermal energy for a given process, depending e.g. on the amount of material to ben dried.

The control entity may be configured to control an amount of recovered thermal energy, recovered liquid, and/or recovered gas flow that is recirculated.

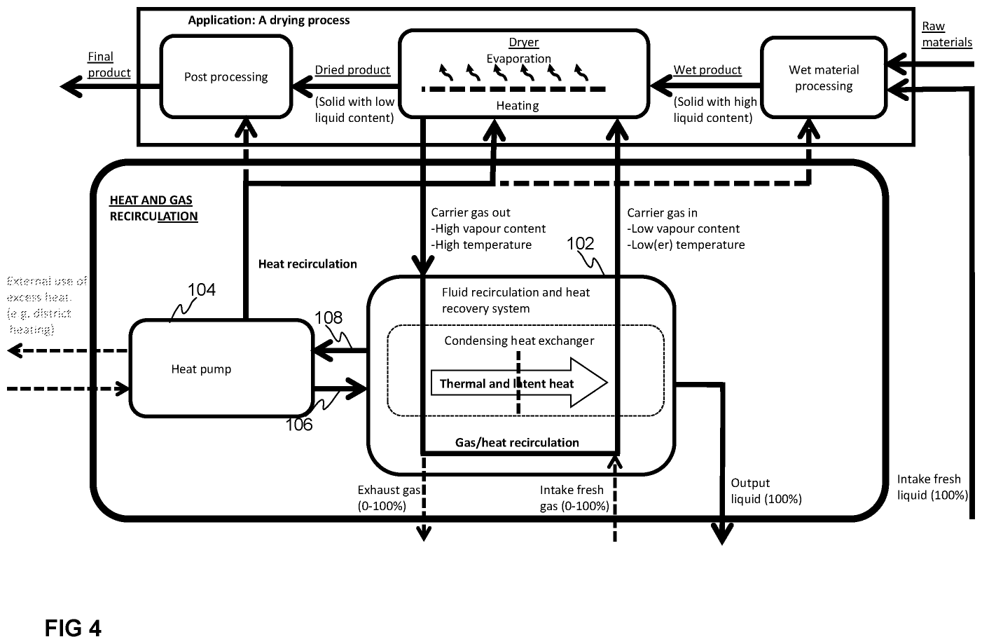

FIGS. 4-6 show different embodiments of the invention, where used heat (thermal energy), liquid, and/or gas flow may be recovered and recirculated back into the manufacturing process (wet and/or drying process) or recovered and directed to an external entity for use.

In the process of FIG. 4, gas flow and thermal energy may be recirculated at least partially in the material manufacturing process. The recovered gas flow may be directed in an exhaust gas flow to an external entity and/or be provided into the environment.

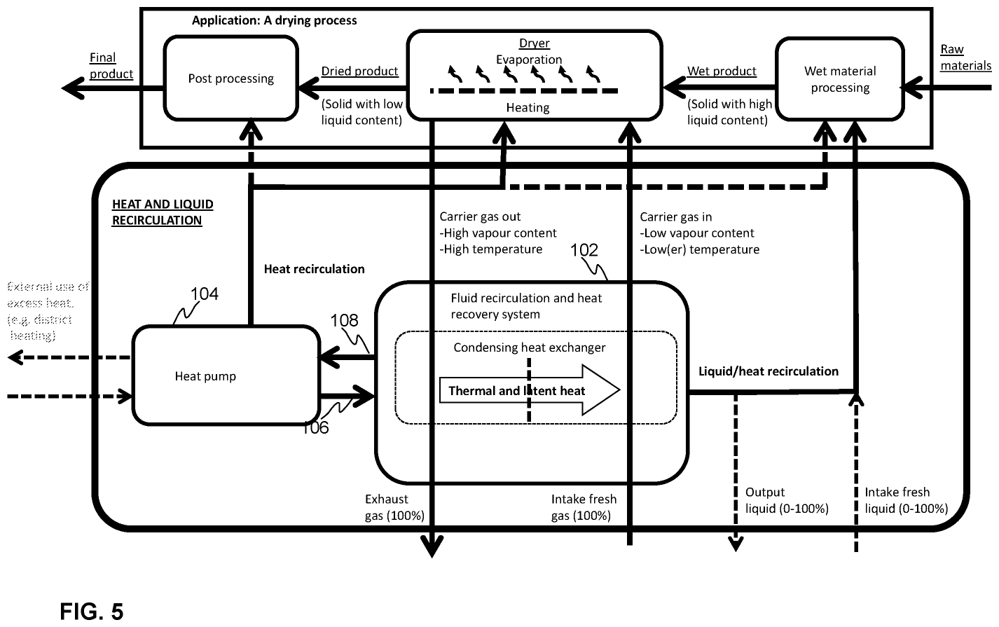

FIG. 5 depicts a process where thermal energy and liquid may be recirculated, while recovered gas flow is provided as exhaust gas to one or more external entities or into the environment.

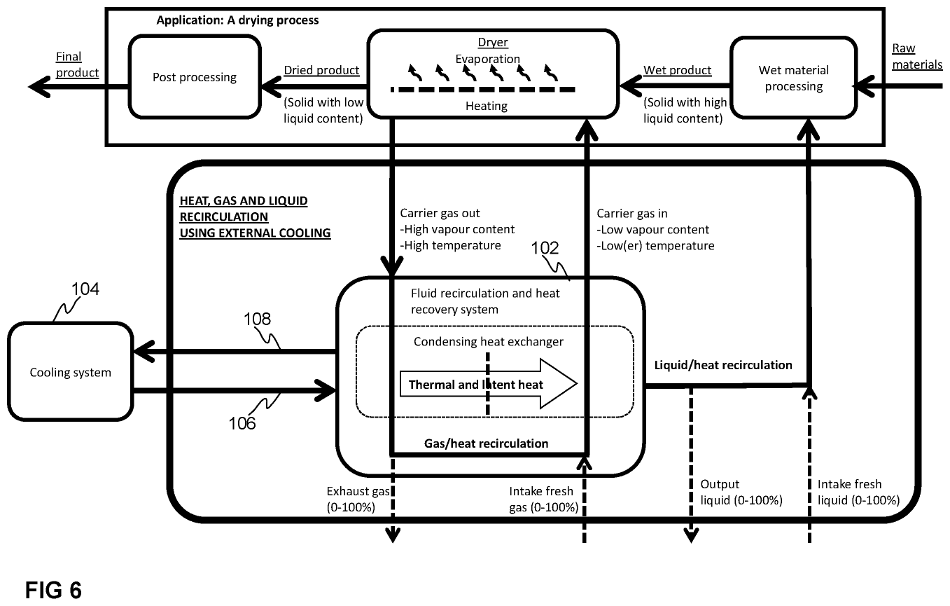

In the embodiment of FIG. 6, thermal energy, gas flow and liquid may be recirculated to the manufacturing process. The device 104 for providing a cooling fluid to the condensing heat exchanger unit 102 is a cooling system that may be some other cooling system that is not a heat pump unit. Here, the cooling system may be considered as an external cooling system, while in some embodiments it may be considered also as being comprised in a heat recovery system. FIG. 6 may depict an embodiment of the invention where additional thermal energy that is directed to the cooling fluid is not recovered and directed to an external unit and/or recirculated into the drying process. The cooling system 104 may e.g. be a cooling system that utilizes cooling fluid obtained from the environment, such as water from a lake or river, for example, as the cooling fluid that is directed to the condensing heat exchanger unit 102.

The cooling system 104 of FIG. 6 may also be replaced with a heat pump unit 104 to provide a process where also the additional thermal energy that is directed to the cooling fluid is recovered and put to use, as discussed previously.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. A method for recovering thermal energy in a material drying process, the method comprising, at least after a starting phase where a starting volume of liquid and a starting amount of gas flow is obtained,
providing a material to be dried comprising a liquid content,
providing thermal energy to evaporate at least a portion of the liquid from the material,
providing a drying gas flow to carry the vapor of the evaporated liquid and the related latent heat from the material,
gathering the gas flow carrying the vapor and the latent heat,
recovering at least most or essentially all of the vapor carried by the gas flow to obtain recovered liquid and recovered gas flow by condensing the at least most or essentially all of the vapor content in the gathered gas flow,
recovering the thermal energy used for evaporation and the latent heat of vapor carried by the gas flow by heat exchanging and condensing to obtain recovered thermal energy by the heat exchanging and condensing,
recirculating at least a portion of the recovered thermal energy as the thermal energy used for evaporation and/or
recirculating at least a portion of the recovered gas flow as the drying gas flow, and/or
recirculating at least a portion of the recovered liquid to the material to be dried comprising a liquid content.

2. The method of claim 1, wherein the method is a closed process with respect to the liquid.

3. The method of claim 1, wherein the method is a closed process with respect to the gas flow and the method comprises recirculating at least most or essentially all of the recovered gas flow as the drying gas flow.

4. The method of claim 1, wherein the method comprises directing the gas flow carrying the vapor and the latent heat to a heat recovery unit comprising at least a condensing heat exchanger unit, wherein the cooling fluid is provided by a cooling fluid providing device for providing a cooling fluid to the condensing heat exchanger unit for exchanging the heat from the drying gas flow by the heat exchanger and thereby cooling the gas flow and condensing the liquid carried by the gas flow to recover also said latent heat from the gas flow, and directing at least a portion of the thus obtained recovered thermal energy to said cooling fluid.

5. The method of claim 4, wherein the cooling fluid is provided by a heat pump unit, and the method comprises directing at least a portion of recovered thermal energy obtained at the condensing heat exchanger unit to the heat pump unit to recover additional thermal energy from the recovered thermal energy obtained at the condensing heat exchanger unit to obtain further recovered thermal energy, and directing said recovered additional thermal energy to an external unit and/or recirculating the additional recovered thermal energy as the thermal energy used for evaporation and/or the processing of the material to be dried.

6. The method of claim 1, wherein the method comprises recovering at least 50% to 80% of the thermal energy used for evaporation.

7. The method of claim 1, wherein at least a portion of the recovered thermal energy is provided at least to the drying gas flow, the method comprising heating the drying gas flow to a temperature of under 200° C.

8. The method of claim 1, wherein the material is a mixture comprising fibers, and liquid, the method comprising mixing fibers and at least one liquid, the at least one liquid comprising water.

9. The method of claim 1, wherein the thermal energy is provided at least to the drying gas flow and optionally to a drying surface on which said material is received.

10. The method of claim 1, wherein the gas flow carrying the vapor and the latent heat is cooled to at least a dew point temperature of the gas flow in order to recover the latent heat by the condensing.

11. A heat recovery system for recovering thermal energy used in a material drying process, configured to receive a drying gas flow carrying vapor of evaporated liquid and the related latent heat from a material comprising liquid content from which said liquid content has been evaporated using thermal energy, and transfer heat from the drying gas flow by a heat exchanger to cool said drying gas flow to condense essentially all or at least most of the vapor to provide a recovered liquid, recovered gas flow, and recovered thermal energy by the heat exchanging and condensing.

12. The heat recovery system of claim 11, wherein the heat recovery system comprises at least a condensing heat exchanger unit and a device for providing a cooling fluid to the condensing heat exchanger unit for exchanging the heat from the drying gas flow by the heat exchanger and thereby cooling the gas flow and condensing the liquid carried by the gas flow to recover also said latent heat from the gas flow, and direct at least a portion of the thus obtained recovered thermal energy to said cooling fluid.

13. The heat recovery system of claim 12, additionally comprising a thermal energy recirculation system and the device for providing said cooling fluid is a heat pump unit, wherein the condensing heat exchanger unit is configured to direct at least a portion of the obtained recovered thermal energy to the heat pump unit to recover further thermal energy from the recovered thermal energy obtained at the condensing heat exchanger unit to obtain additional recovered thermal energy, and said heat pump unit is configured to direct said recovered additional thermal energy to an external unit and/or recirculating the additional recovered thermal energy as the thermal energy used for evaporation and/or the processing of the material to be dried.

14. The heat recovery system of claim 11, additionally comprising a liquid recirculation system configured to receive the recovered liquid and recirculate the recovered liquid to a mixing unit for mixing the material with the liquid to provide the material comprising liquid content.

15. The heat recovery system of claim 11, additionally comprising a gas flow recirculation system configured to receive the recovered gas flow and recirculate the recovered gas flow as the drying gas flow in the process for drying material.

16. An arrangement for receiving a material comprising liquid content and drying said material, the arrangement comprising at least a heat recovery system according to claim 11 and at least one gas flow element for providing a drying gas flow and at least one heating element for providing thermal energy for evaporating the liquid from the material.

17. The arrangement of claim 16 additionally comprising a mixing unit configured to receive a material and mix said material with the liquid to obtain a material comprising liquid content.

18. The arrangement of claim 16, the arrangement additionally comprising a drying surface configured to receive the material to be dried.

19. The arrangement of claim 16, the arrangement additionally comprising a control entity configured to receive one or more determined parameters, wherein the control entity is configured to control an amount of thermal energy provided by the at least one heating element and/or control an amount of gas flow provided by the at least one gas flow element based on said determined parameters.
